(19) United States
(12) Patent Application Publication
(10) Pub. No.: US 2012/0050700 A1
(43) Pub. Date: Mar. 1, 2012

(54) LIGHT ADJUSTMENT SYSTEM AND METHOD

(75) Inventor: PO-CHANG WANG, Tu-Cheng (TW)

(73) Assignee: HON HAI PRECISION INDUSTRY CO., LTD., Tu-Cheng (TW)

(21) Appl. No.: 13/198,714

(22) Filed: Aug. 5, 2011

(30) Foreign Application Priority Data
Aug. 26, 2010 (CN) 201010263710.5

(51) Int. Cl. G03B 21/28; G03B 21/00

(52) U.S. Cl. 353/99; 353/121

(57) ABSTRACT

A projector and method adjusts light. The projector obtains coordinates of each pixel of an image of a projection screen captured by a camera. Furthermore, the projector converts the coordinates of the pixels of a predetermined shape in the image into the coordinates of the pixels of a DMD chip. The projector adjusts an angle of micromirrors corresponding to the converted coordinates of the pixels of the DMD chip to direct light away from a lens of the projector.

### BACKGROUND

1. Technical Field

Embodiments of the present disclosure relate to projector technology, and particularly to a light adjustment system and method for a projector.

2. Description of Related Art

Projectors are devices designed to project images onto a projection screen. People often use projectors to make presentations. However, the light from the projector is very strong, and the light may hurt the eyes of the people if they happen to directly look at the projector when addressing their audience.

### BRIEF DESCRIPTION OF THE DRAWINGS

FIG. 1 is a system view of one embodiment of a light adjustment system.

FIG. 2 is a block diagram of one embodiment of a projector of FIG. 1.

FIG. 3 is a flowchart of one embodiment of a light adjustment method.

FIG. 4 illustrates one embodiment of a projection screen and a projection area of the projection screen.

FIG. 5 illustrates one embodiment of an image of the projection screen captured by a camera of the projector.

FIG. 6 illustrates one embodiment of the predetermined shape in the image of the projection screen projected on the projection area of the projection screen.

FIG. 7 illustrates light directed through a lens of the projector by a micromirror of a digital micromirror device in one embodiment.

FIG. 8 illustrates light directed away from the lens of the projector by the micromirror of the digital micromirror device in one embodiment.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

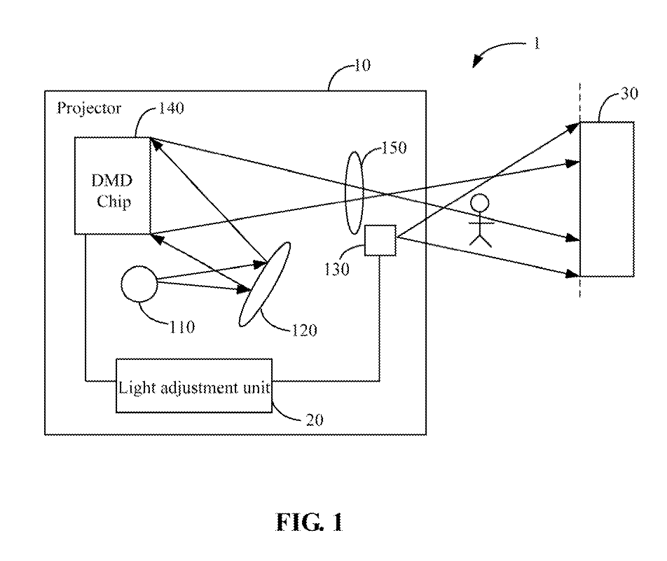

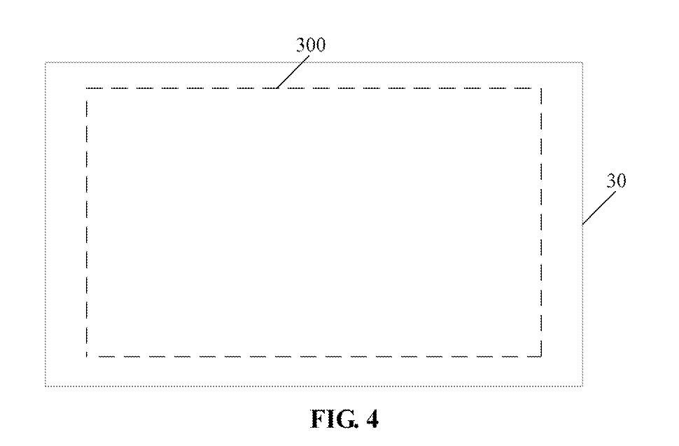

FIG. 1 is a system view of one embodiment of a light adjustment system 1. In one embodiment, the light adjustment system 1 may include a projector 10 and a projection screen 30. The light adjustment system 1 may be used to prevent harm to eyes of a user by light from the projector 10. The projection screen 30 includes a projection area 300, as shown in FIG. 4. The projector 10 projects images, slides or videos on the projection area 300. The projector 10 may be, but is not limited to, a digital light processing (DLP) projector.

The projector 10 includes an illuminator 110, a reflector 120, a camera 130, a digital micromirror device (DMD) chip 140, and a lens 150. In one embodiment, the illuminator 110 generates light and sends the light to the reflector 120. The reflector 120 reflects the light from the illuminator 110 to the DMD chip 140. In other embodiments, the reflector 120 can be omitted, and the illuminator 110 can directly send the light to the DMD chip 140. The illuminator 110 may be, but is not limited to, a light emitting diode (LED) illuminator, a laser illuminator, or an organic electro luminescent (OEL) illuminator. The camera 130 captures an image of the projection screen 30. In one embodiment, the camera 130 can be separated from the projector 30 and run independently. Additionally, the projector 10 includes a light adjustment unit 20. Further details of the light adjustment unit 20 will be described below.

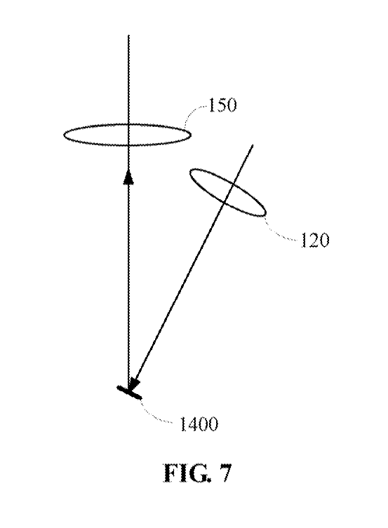

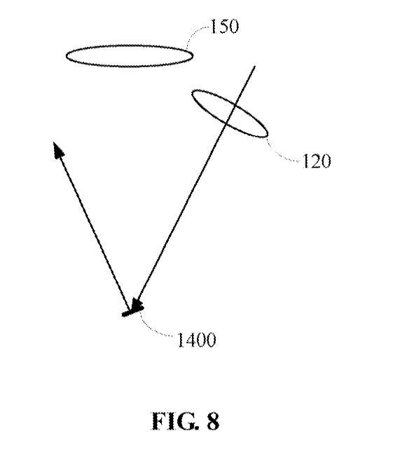

In one embodiment, a plurality of micromirrors 1400 are arranged in a rectangular array on a surface of the DMD chip 140. Each micromirror 1400 corresponds to a pixel of the DMD chip 140. For example, if the DMD chip 140 has a resolution of 1024×768 pixels, the DMD chip 140 includes 1024×768 micromirrors. For distinguishing pixels of the camera 13, hereinafter, the pixels of the DMD chip 140 are mentioned as first pixels. Additionally, the micromirrors 1400 can be individually rotated to achieve a desired angle ranging from about −10° to about 10°. In one embodiment, if the micromirror 1400 is rotated to a position of 10°, the micromirror 140 is turned into an on state. If the micromirror 1400 is rotated to a position of −10°, the micromirror 140 is turned into an off state. In the on state, as shown in FIG. 7, the micromirror 1400 is at 10°, and the light from the illuminator 110 is reflected to the lens 150 to make the first pixels corresponding to the micromirror 1400 appear bright on the projection screen 30. In the off state, as shown in FIG. 8, the micromirror 1400 is at −10°, and the light is directed elsewhere to make the first pixels corresponding to the micromirror 1400 appear dark on the projection screen 30.

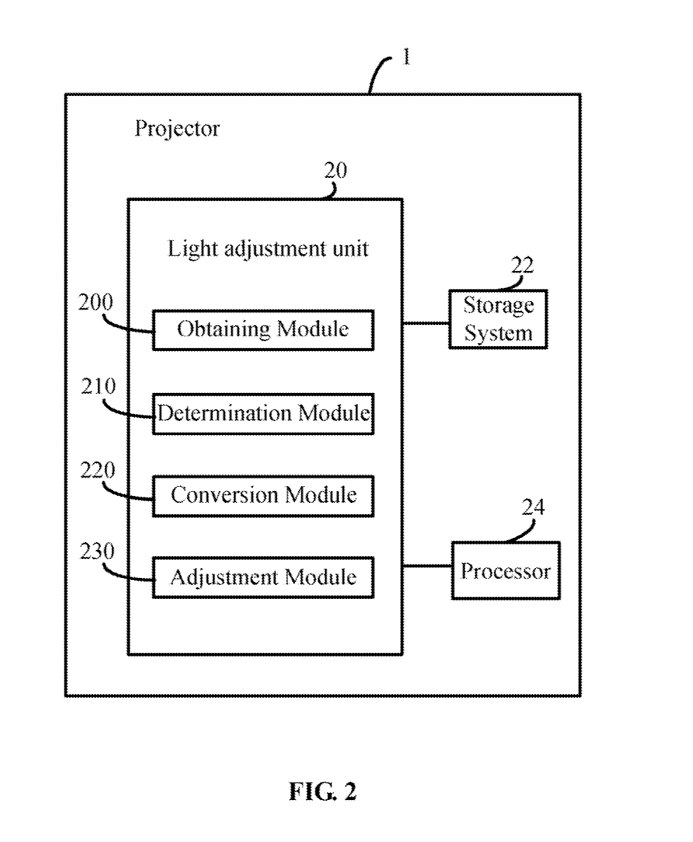

FIG. 2 is a block diagram of one embodiment of the projector 10 including the light adjustment unit 20. The light adjustment unit 20 may be used to automatically adjust light of the projector 10 when a user sits in front of the projector. In one embodiment, the projector 10 includes a storage system 22, and at least one processor 24. The light adjustment unit 20 includes an obtaining module 210, a determination module 220, a conversion module 230, and an adjustment module 240. The modules 210-240 may include computerized code in the form of one or more programs that are stored in a storage system 22. The computerized code includes instructions that are executed by the at least one processor 24 to provide functions for modules 210-240. The storage system 22 may be a cache, a memory, a flash or a hard drive.

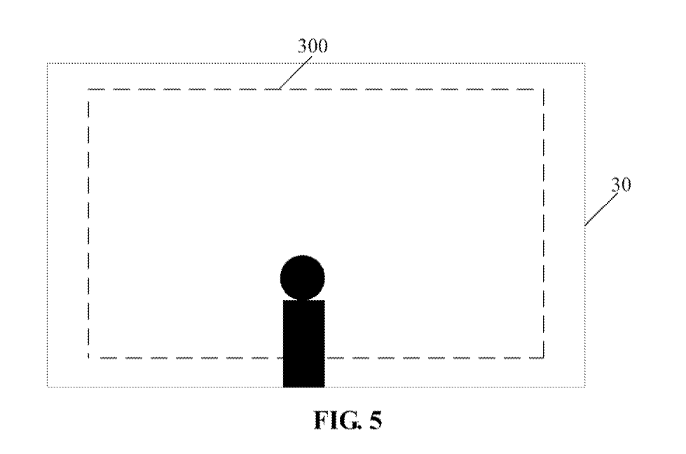

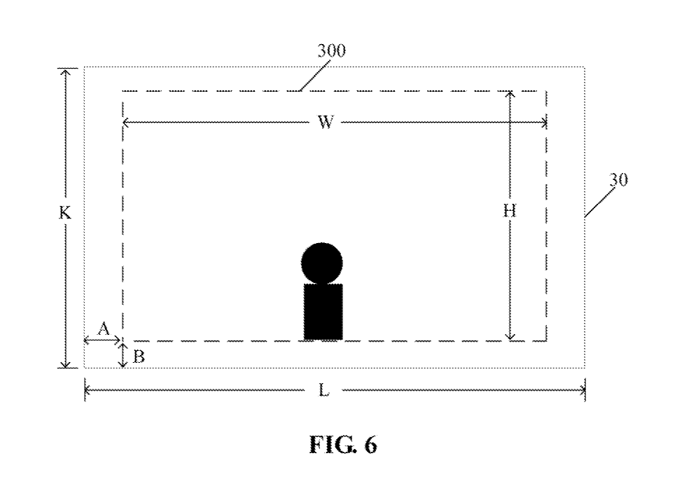

The obtaining module 210 obtains coordinates of each pixel of the image of the projection screen 30 captured by the camera 130. To distinguish the pixels of the DMD chip 140 from the pixels of images captured by the camera 130, the pixels of the images are hereinafter referred to second pixels. As shown in FIG. 5, the image may include an object (e.g., a human figure) where is put in front of the projector 10. The human figure is projected onto the projection area 300, as shown in FIG. 6.

The determination module 220 determines if the image of the projection screen 30 includes a predetermined shape. The predetermined shape is a human shape. In one embodiment, the determination module 220 determines if the image of the projection screen 30 includes the human shape.

The conversion module 230 converts the coordinates of the second pixels of the predetermined shape in the image into the coordinates of first pixels. As shown in FIG. 6, the projection screen 30 includes L*M second pixels and the projection area 300 includes W*H second pixels. The distance from edge of a width of the projection screen 30 to the edge of a width of the projection area 300 includes A second pixels. The distance from edge of a height of the projection screen 30 to the edge of the height of the projection area 300 includes B second pixels. The DMD chip 140 includes M*N first pixels. The conversion module 230 converts the coordinates of the second pixels of the predetermined shape in the image into the coordinates of first pixels in the following example: X2=((X1−A)/W)*M, Y2=((Y1−B)/H)*N, where (X1, Y1) are the coordinates of the second pixels of the predetermined shape in the image, the (X2, Y2) are the converted coordinates of the first pixels.

The adjustment module 240 adjusts an angle of micromirrors 1400 corresponding to the converted coordinates of the first pixels to direct light through the lens 150 of the projector 10. For example, as shown in FIG. 7 and FIG. 8, the adjustment module 240 adjusts the angle of micromirrors 1400 from 10° to −10° so that the light directs away from the lens 150.

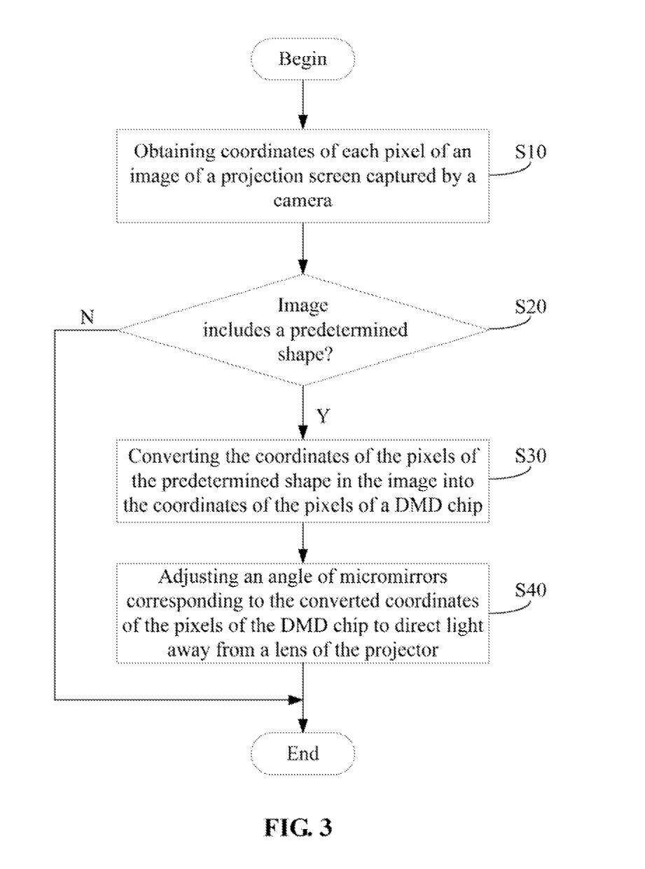

FIG. 3 is a flowchart of one embodiment of a light adjustment method. Depending on the embodiment, additional blocks may be added, others deleted, and the ordering of the blocks may be changed.

In block S10, the obtaining module 210 obtains coordinates of each second pixel of the image of the projection screen 30 captured by the camera 130. The image may include an outline of an object (e.g., a human figure) caused by their shadow being projected onto the screen 30. In one embodiment, as shown in FIG. 5, the image captured by the camera 130 includes a human figure. The human figure is projected on the projection area 300, as shown in FIG. 6.

In block S20, the determination module 220 determines if the image of the projection screen 30 includes a predetermined shape. As mentioned above, the determination module 220 determines if the image of the projection screen 30 includes the human shape.

In block S30, the conversion module 230 converts the coordinates of the second pixels of the predetermined shape in the image into the coordinates of first pixels. As shown in FIG. 6, the projection screen 30 includes L*M second pixels and the projection area 300 includes W*H second pixels. The distance from edge of a width of the projection screen 30 to the edge of a width of the projection area 300 includes A second pixels. The distance from edge of a height of the projection screen 30 to the edge of the height of the projection area 300 includes B second pixels. The DMD chip 140 includes M*N first pixels. The conversion module 230 converts the coordinates of the second pixels of the predetermined shape in the image into the coordinates of first pixels as in one example follows: X2=((X1−A)/W)*M, Y2=((Y1−B)/H)*N, where (X1, Y1) are the coordinates of the second pixels of the predetermined shape in the image, the (X2, Y2) are the converted coordinates of the first pixels.

In block S40, the adjustment module 240 adjusts an angle of micromirrors 1400 corresponding to the converted coordinates of the first pixels to avoid light to pass through the lens 150 of the projector 10. For example, as shown in FIG. 7 and FIG. 8, the adjustment module 240 adjusts the angle of micromirrors 1400 from 10° to −10° so that the light directs away from the lens 150.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A projector, comprising:
a digital micromirrors device (DMD) chip comprising one or more micromirrors;
a lens;
a storage system;
at least one processor; and
one or more programs stored in the storage system and being executable by the at least one processor, the one or more programs comprising:
an obtaining module operable to obtain coordinates of each pixel of an image of a projection screen of the projector captured by a camera;
a determination module operable to determines if the image of the projection screen comprises a predetermined shape;
a conversion module operable to convert the coordinates of the pixels of the predetermined shape in the image into the coordinates of the pixels of the DMD chip, in response to a determination that the image of the projection screen includes the predetermined shape; and
an adjustment module operable to adjusts an angle of micromirrors corresponding to the converted coordinates of the pixels of the DMD chip to direct light away from the lens.

2. The projector of claim 1, wherein the projector is a digital light processing (DLP) projector.

3. The projector of claim 1, wherein the micromirrors are arranged in a rectangular array on a surface of the DMD chip of the projector and can be individually rotated between a minus desired angle to a plus desired angle.

4. The projector of claim 1, wherein the predetermined shape is a human shape.

5. A light adjustment method implemented by a projector, the method comprising:
obtaining coordinates of each pixel of an image of a projection screen of the projector captured by a camera;
determining if the image of the projection screen includes a predetermined shape;
converting the coordinates of the pixels of the predetermined shape in the image into the coordinates of the pixels of a digital micromirrors device (DMD) chip, in response to a determination that the image of the projection screen includes the predetermined shape; and
adjusting an angle of micromirrors corresponding to the converted coordinates of the pixels of the DMD chip to direct light away from a lens of the projector.

6. The method of claim 5, wherein the projector is a digital light processing (DLP) projector.

7. The method of claim 5, wherein the micromirrors are arranged in a rectangular array on a surface of the DMD chip of the projector and can be individually rotated between a minus desired angle to a plus desired angle.

8. The method of claim 5, wherein the predetermined shape is a human shape.

9. A non-transitory computer-readable medium having stored thereon instructions that, when executed by a projector, causing the projector to perform a light adjustment method, the method comprising:
obtaining coordinates of each pixel of an image of a projection screen of the projector captured by a camera;
determining if the image of the projection screen includes a predetermined shape;
converting the coordinates of the pixels of the predetermined shape in the image into the coordinates of the pixels of a digital micromirrors device (DMD) chip, in response to a determination that the image of the projection screen includes the predetermined shape; and
adjusting an angle of micromirrors corresponding to the converted coordinates of the pixels of the DMD chip to direct light away from a lens of the projector.

10. The medium of claim 9, wherein the projector is a digital light processing (DLP) projector.

11. The medium of claim 9, wherein the micromirrors are arranged in a rectangular array on a surface of the DMD chip of the projector and can be individually rotated between a minus desired angle to a plus desired angle.

12. The medium of claim 9, wherein the predetermined shape is a human shape.
